(19) United States
(12) Patent Application Publication
(10) Pub. No.: US 2023/0325551 A1
(43) Pub. Date: Oct. 12, 2023

(54) MULTI-HAZARD ACCIDENT COUPLING THREE-DIMENSIONAL SIMULATION SYSTEM FOR MAJOR OIL AND GAS INFRASTRUCTURE

(71) Applicant: SOUTH CHINA UNIVERSITY OF TECHNOLOGY, Guangzhou (CN)

(72) Inventors: Guohua CHEN, Guangzhou (CN); Lixing ZHOU, Guangzhou (CN); Jinkun MEN, Guangzhou (CN); Chennan LUO, Guangzhou (CN); Xiaohui RAO, Guangzhou (CN)

(73) Assignee: SOUTH CHINA UNIVERSITY OF TECHNOLOGY, Guangzhou (CN)

(21) Appl. No.: 17/786,543

(22) PCT Filed: Apr. 10, 2021
(86) PCT No.: PCT/CN2021/086301

§ 371 Date: Jun. 17, 2022

(30) Foreign Application Priority Data
Feb. 20, 2021 (CN) 202110193025.8

(51) Int. Cl. G06F 30/18; G06T 17/00; G06Q 50/06; G06Q 10/067; G06Q 10/0637

(52) U.S. Cl. CPC G06F 30/18; G06T 17/00; G06F 2113/08; G06Q 10/067; G06Q 10/0637; G06Q 50/06

(57) ABSTRACT

Disclosed by the present invention is a multi-hazard accident coupling three-dimensional simulation system for a major oil and gas infrastructure, including an accident three-dimensional simulation module, an accident chain evolution prediction module, a model unit, and a database module. On the basis of an existing Natech accident analysis method, a Natech accident multi-hazard coupling link of a major infrastructure for oil and gas storage and transportation is considered, and all potential accident link possibilities are identified. In daily management, the accident probabilities and accident consequences of various units under multi-hazard coupling are analyzed to provide a basis for reasonable arrangement of safety protection facilities and emergency evacuation drill. In the emergency rescue stage after the accident occurs, the most probable propagation path and evolution time of the accident under multi-hazard coupling are analyzed to provided decision support for the development of emergency rescue actions.

### BACKGROUND

### Technical Field

The present invention relates to the field of accident simulation, and in particular relates to a multi-hazard accident coupling three-dimensional simulation system for a major oil and gas infrastructure.

### Description of Related Art

With the frequent occurrence of major and serious natural hazards, key devices are prone to undergoing fire disasters, explosions or hazardous chemical leakage and diffusion accidents, these accidents are called Natural events triggering a technological scenario (Natech events), and thermal radiation, overpressure or fragments generated by these accidents can also be coupled with natural hazard factors besides damaging surrounding adjacent devices, leading to a more complex and more severe damage disaster-causing process. Once multi-hazard coupling accidents are caused by earthquakes, typhoons, floods, thunder and lightning, geological disaster accidents and the like, great damage to the major infrastructures for oil and gas storage and transportation and the surrounding personnel is likely to be caused, leading to great threats to economic development and social stability. Such accidents belong to typical high-influence low-probability events. An existing accident simulation system is focused on the calculation of a single accident consequence and does not comprehensively consider the accident consequence upgrade of the major oil and gas infrastructure caused by the simultaneous action of natural hazards and technological hazards.

### SUMMARY

Provided by the present invention is a multi-hazard accident coupling three-dimensional simulation system for a major oil and gas infrastructure. The system is used for predicting an accident development link, analyzing the most probable propagation path and evolution time of an accident under multi-disaster coupling, and simulating an accident propagation link and accident consequences, thus providing a decision support for the development of emergency rescue actions.

The present invention is achieved through the following technical solutions.

A multi-hazard accident coupling three-dimensional simulation system for a major oil and gas infrastructure includes an accident three-dimensional simulation module, an accident chain evolution prediction module, a model module, and a database module,

the accident three-dimensional simulation module and the accident chain evolution prediction module are respectively in signal connection with the model module and the database module, and the accident three-dimensional simulation module is in signal connection with the accident chain evolution prediction module; wherein

the accident three-dimensional simulation module is used for the mirror mapping of a basic scenario of a major infrastructure for oil and gas storage and transportation and the generation of a three-dimensional accident consequence;

the accident chain evolution prediction module is used for predicting a multi-hazard coupling accident scenario of a major oil and gas infrastructure domino accident caused by a Natech accident;

the model module is used for providing models for the accident three-dimensional simulation module and the accident chain evolution prediction module; and

the database module is used for providing real-time data for the accident three-dimensional simulation module and the accident chain evolution prediction module.

Further, the accident three-dimensional simulation module includes a basic scenario generating module and an accident consequence simulation module; the basic scenario generating module is used for achieving the mirror mapping of the major infrastructure for oil and gas storage and transportation, including geological information, building distributions, traffic facilities, large equipment profiles and surroundings (e.g., sky, topography), and the like; and the accident consequence simulation module is used for simulating the multi-hazard coupling accident consequence of the major oil and gas infrastructure domino accident caused by the Natech accident.

Further, the basic scenario generating module includes an oblique photography unit, a laser point cloud unit, and a three-dimensional modeling unit; the oblique photography unit is used for the three-dimensional surveying and mapping of an outdoor basic scenario of the major infrastructure for oil and gas storage and transportation, the laser point cloud unit is used for the fine modeling of an indoor basic scenario of the major infrastructure for oil and gas storage and transportation, and the three-dimensional modeling unit is used for the supplementary modeling of an underground basic scenario and an overground basic scenario of the major infrastructure for oil and gas storage and transportation.

Further, the accident consequence simulation module includes an accident consequence calculation unit and an accident consequence visualization unit; the accident consequence calculation unit is used for calculating an accident consequence, and the accident consequence visualization unit is used for performing dynamic simulation according to the accident consequence.

Further, the accident consequence includes an accident influence range, the number of possible casualties and property loss.

Further, the accident consequence visualization unit is used for rendering dynamic accident consequences of diffusion, flame, explosion, shock wave and high-speed fragments at the periphery of corresponding equipment in the basic scenario of the major infrastructure for oil and gas storage and transportation according to the accident consequences calculated by the accident consequence calculation unit.

Further, the model module includes a coupling probability model unit and an accident consequence model unit; the coupling probability model unit includes damage-causing models of hazard-causing factors of various types of hazards for main facilities in the major infrastructure for oil and gas storage and transportation, and the accident consequence model unit includes accident consequence calculation modules of various types of hazards.

Further, the database module includes an Internet of Things perception base, a geographic information base, a scenario base, and a hazardous chemical information base, wherein

the Internet of Things perception base is used for storing sensor data of various perception equipment in a major oil and gas infrastructure scenario;

the GIS geographic information base is used for storing geographic information of buildings and facility equipment on a map;

the scenario base is used for storing three-dimensional models of various buildings and facility equipment for the calling of the accident three-dimensional simulation module; and

the hazardous chemical information base is used for storing physicochemical property information corresponding to various hazardous chemicals in the major infrastructure for oil and gas storage and transportation.

Further, the database module further includes a management information base and an enterprise base, wherein

the management information base is used for storing platform login account information; and

the enterprise information base is used for storing enterprise management data.

Further, the sensor data stored in the Internet of Things perception base includes static data and dynamic data.

### Beneficial Effect

Compared with the prior art, the present invention can achieve the beneficial effects at least as follows.

(1) On the basis of an existing Natech accident analysis method, the system identifies the multi-hazard coupled links of the Natech accidents of the major infrastructure for oil and gas storage and transportation, and can identify all potential accident links possible.

(2) By integrating the software technologies of oblique photography, laser point cloud and three-dimensional modeling, the system can achieve accurate and realistic restoration of outdoor, indoor and underground full-scenario facilities of the major infrastructure for oil and gas storage and transportation.

(3) In daily management, the system can analyze the accident probabilities and accident consequences of various units under multi-hazard coupling to provide a basis for reasonable arrangement of safety protection facilities and emergency evacuation drill; and in the emergency rescue stage after the accident occurs, the system can analyze the most probable propagation path and evolution time of the accident under multi-hazard coupling to provide a decision support for the development of emergency rescue actions.

### BRIEF DESCRIPTION OF THE DRAWINGS

FIG. 1 is a structure diagram of a multi-hazard accident coupling three-dimensional simulation system for a major oil and gas infrastructure in accordance with the present invention.

FIG. 2 is a schematic diagram of an accident chain evolution prediction module in accordance with the present invention.

FIG. 3 is a schematic diagram of element classification in a scenario base in accordance with the present invention.

### DESCRIPTION OF THE EMBODIMENTS

The present invention is further specifically described in detail below with reference to the specific embodiments.

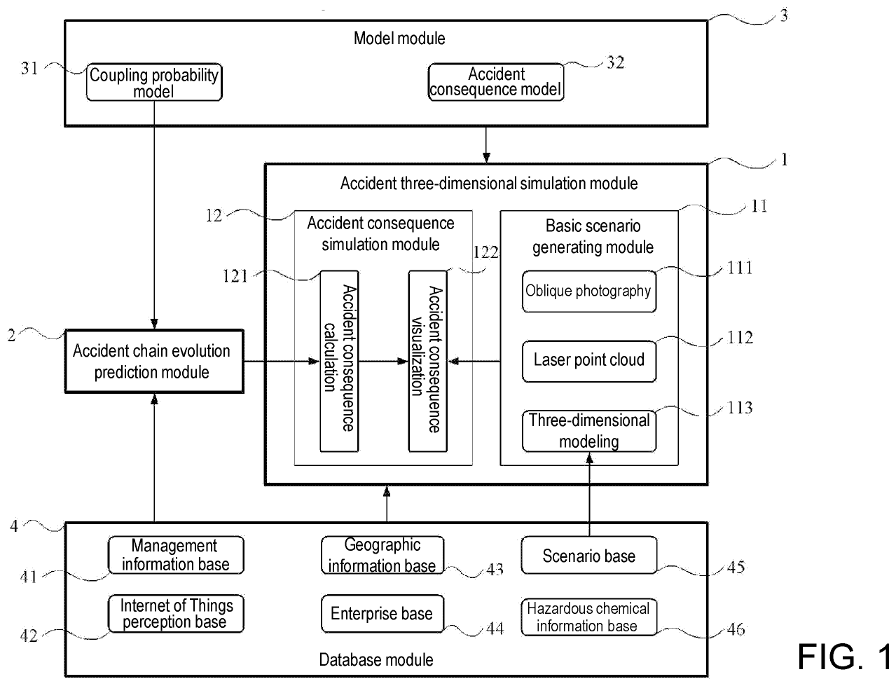

As shown in FIG. 1, an embodiment of the present invention provides a multi-hazard accident coupling three-dimensional simulation system for a major oil and gas infrastructure, which includes four modules which are an accident three-dimensional simulation module 1, an accident chain evolution prediction module 2, a model module 3, and a database module 4, respectively. The accident three-dimensional simulation module 1 and the accident chain evolution prediction module 2 are respectively in signal connection with the model module 3 and the database module 4; and the accident three-dimensional simulation module 1 is in signal connection with the accident chain evolution prediction module 2.

The model module 3 is used for providing calculation models for the accident three-dimensional simulation module 1 and the accident chain evolution prediction module 2, and includes a coupling probability model unit 31 and an accident consequence model unit 32.

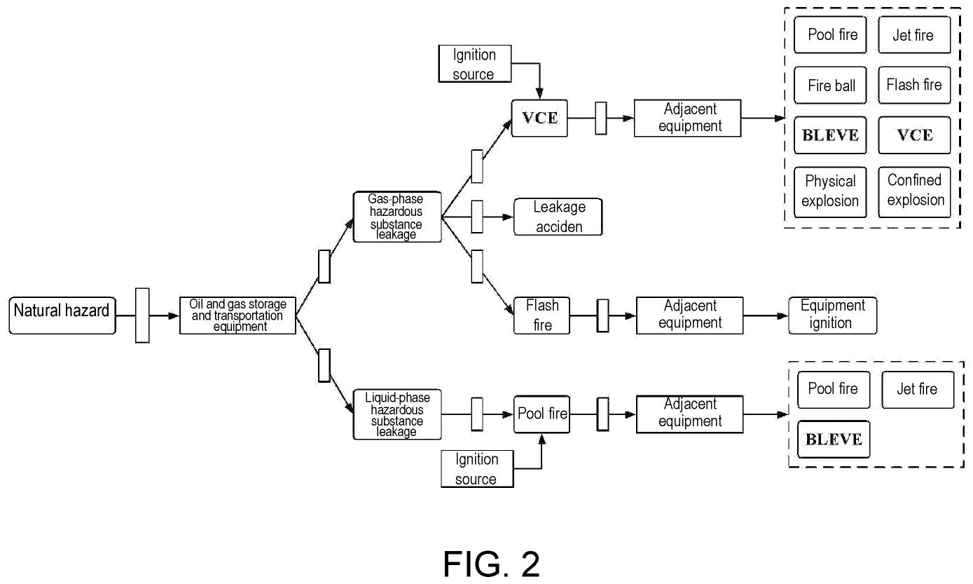

The coupling probability model unit 31 includes damage-causing models of hazard-causing factors of any natural hazards such as thunder and lightning, floods, typhoons, earthquakes and the like and hazard-causing factors of technological hazards such as shock waves, thermal radiation and high-speed fragments, which are known by those skilled in the art, for main facilities in the major infrastructure for oil and gas storage and transportation. The failure probability of each equipment can be calculated based on the damage-causing model, the accident link can then be predicted by combining an evolution event tree (please referring to FIG. 2) of the Natech accident of the major oil and gas infrastructure, the occurrence probability of each accident link is calculated, and the accident link with the maximum probability is output. Therefore, the related link prediction can utilize any link prediction method known by those skilled in the art, such as a Monte Carlo simulation-based prediction method, a Bayesian network-based prediction method, and a cellular automaton-based prediction method.

The accident consequence model unit 32 includes any accident consequence calculation module known by those skilled in the art, such as a gas leakage amount calculation model, a gas diffusion model, a liquid leakage model, a pool fire accident consequence model, a jet fire accident consequence model, a fireball model, a flash fire model, a vapor cloud explosion model, and a boiling gas expand vapor explosion model.

The database module 4 is used for providing real-time data for the accident three-dimensional simulation module 1 and the accident chain evolution prediction module 2 in the system, and includes a management information base 41, an Internet of Things perception base 42, a geographic information base 43, an enterprise base 44, a scenario base 45, and a hazardous chemical information base 46.

The management information base 41 is used for storing platform login account information.

The Internet of Things perception base 42 is used for storing sensor data of various perception equipment in a major oil and gas infrastructure scenario, specifically including static data such as the type and nature of hazard sources in the scenario, vulnerability targets, number and location of monitoring equipment and monitoring objects, and real-time dynamic data such as the number of hazard sources and weather information surrounding the scenario.

The GIS geological information base 43 is used for storing detailed geological information of buildings and facility equipment on a map.

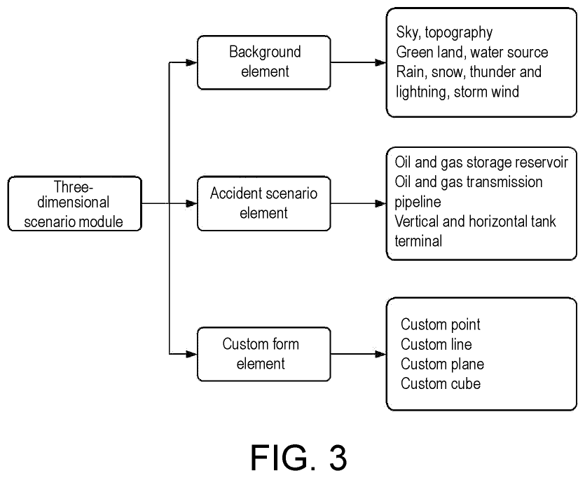

The scenario base 45 is used for storing three-dimensional models of various common buildings and facility equipment of the major infrastructure for oil and gas storage and transportation which are constructed in advance by modeling software such as 3Ds Max and CAD, wherein the three-dimensional models constructed in advance can all be moved, zoomed and rotated freely so as to be rapidly called during modeling of the three-dimensional modeling unit 113. As shown in FIG. 3, the scenario base 45 includes three types of elements, which are background elements, accident scenario elements, and custom form elements, respectively. The background elements include universal scenario elements such as sky, green lands, water sources, rain and snow, thunder and lightning, floods, and storm wind; the accident scenario elements include scenario elements dedicated for the major oil and gas infrastructure such as topography, buildings, equipment facilities, and underground pipelines; and the custom form elements include common custom points, custom lines, custom planes and custom cubes for modifying the three-dimensional scenario.

The hazardous chemical information base 46 is used for storing physicochemical property information corresponding to various hazardous chemicals in the major infrastructure for oil and gas storage and transportation, such as melting points, boiling points, flash points, ignition points and any other relevant physicochemical information in this field.

The accident three-dimensional simulation module 1 receives various types of data and information of the accident chain evolution prediction module 2, the model module 3 and the database module 4, and is used for the mirror mapping of a basic scenario of the major infrastructure for oil and gas storage and transportation and the generation of three-dimensional accident consequences and displaying a multi-hazard coupling accident scenario of the major oil and gas infrastructure domino accident caused by the Natech accident; and the accident three-dimensional simulation module includes a basic scenario generating module 11 and an accident consequence simulation module 12.

The basic scenario generating module 11 is used for achieving the mirror mapping of the major infrastructure for oil and gas storage and transportation, including geological information, building distributions, traffic facilities, large equipment profiles and surroundings (e.g., sky, topography), and the like; and the accident consequence simulation module 12 is used for simulating a multi-hazard coupling accident consequence of the major oil and gas infrastructure domino accident caused by the Natech accident.

The basic scenario generating module 11 includes an oblique photography unit 111, a laser point cloud unit 112, and a three-dimensional modeling unit 113 which generate a basic scenario of the major infrastructure for oil and gas storage and transportation together. Wherein the oblique photography unit 111 is a main generation technology for an outdoor basic scenario, an unmanned aerial vehicle flying platform carrying a plurality of sensors is used for synchronously acquiring images from different angles to comprehensively perceive complex scenarios in a large-range, high-precision and high-definition mode, thus rapidly achieving three-dimensional surveying and mapping of outdoor basic scenes of the major infrastructure for oil and gas storage and transportation; the laser point cloud unit 112 is a main generation technology for an indoor scenario, a three-dimensional laser scanning technology is used to scan the indoor scenario, and fine modeling of the indoor basic scenario of the major infrastructure for oil and gas storage and transportation can be achieved by performing denoising, compression and smoothing operations on the formed point cloud data and combining a GIS geographic information base 43 of the major infrastructure for oil and gas storage and transportation; and the three-dimensional modeling unit 113 is a main generation technology for an underground scenario and an important supplementary technology for other scenarios, the scenario base 45 is generated by performing three-dimensional modeling on the general profile of the accident scenario in advance by using modeling software such as 3Ds Max and CAD, and the models in the scenario base 45 are called to perform three-dimensional modeling on an underground basic scenario of the accident scenario.

The accident consequence simulation module 12 is used for simulating a multi-hazard coupling accident consequence of the major oil and gas infrastructure domino accident caused by the Natech accident in the basic scenario of the major infrastructure for oil and gas storage and transportation, and includes an accident consequence calculation unit 121 and an accident consequence visualization unit 122.

The accident consequence calculation unit 121 is used for calculating accident consequences such as an accident influence range, the number of possible casualties and property loss by combining a hazardous chemical information base 46 and a calculation model of the corresponding accident in the accident consequence model unit 32 according to the accident link with the maximum probability determined by the accident chain evolution prediction module 2 and accident types and accident consequences corresponding to various equipment; and the accident consequence visualization module 122 is used for rendering dynamic accident consequences of diffusion, flame, explosion, shock wave, high-speed fragments and the like at the periphery of corresponding equipment in the basic scenario of the major infrastructure for oil and gas storage and transportation by utilizing a particle system in a three-dimensional engine according to the data calculated by the accident consequence calculation unit 121.

The accident chain evolution prediction module 2 is used for predicting a multi-hazard coupling accident scenario of a major oil and gas infrastructure domino accident caused by the Natech accident. Natech accident evolution of the major oil and gas infrastructure is as shown in FIG. 2, natural hazards, such as typhoon, flood, earthquake, thunder and lightning, act on the oil and gas storage and transportation equipment to cause the failure thereof; gas-phase hazardous substance leakage and liquid-phase hazardous substance leakage are respectively caused according to different mediums contained in the oil and gas storage and transportation equipment, which further causes various accidents. Mutual coupling of various types of accidents and natural hazards may cause failure of the peripheral equipment and facilities, leading to long-chain accidents in the scenario.

In the gas-phase hazardous substance leakage accident, if the hazardous substance is combustible gas, once the hazardous substance encounters an ignition source, a vapor cloud explosion (VCE) accident can be caused, and the explosion accident will induce adjacent equipment to an accident in the manner of shock waves, thermal radiation, high-speed fragments and the like, which may cause accident types such as pool fires, jet fires, fire balls, flash fires, boiling liquid vapor explosion accidents (BLEVE), physical explosions, and confined explosions; if the hazardous substance is combustible gas but does not encounter an ignition source, a flash fire accident may be caused, and the accident will ignite the adjacent equipment in a manner of thermal radiation and the like; if the hazardous substance is only poisonous and harmful gas, a pool fire accident may be caused, and the pool fire accident will induce the adjacent equipment to an accident in a manner of thermal radiation and the like, which may cause accident types such as pool fires, jet fires, and boiling liquid vapor explosions (BLEVE).

In the liquid-phase hazardous substance leakage accident, if the hazardous substance encounters an ignition source but is not a combustible gas, a poisonous and harmful gas accident may be caused; if the hazardous substance encounters an ignition source and is the combustible gas, an explosion accident may be caused, and the explosion accident will induce the adjacent equipment to an accident in the manner of shock waves, thermal radiation, high-speed fragments and the like, which may cause accident types such as pool fires, jet fires, fire balls, flash fires, boiling liquid vapor explosion accidents (BLEVE), physical explosions, and confined explosions. which may cause accident types such as pool fires, jet fires, fire balls, flash fires, boiling liquid vapor explosion accidents (BLEVE), physical explosions, and confined explosions.

On the basis of an existing Natech accident analysis method, the domino accident risk assessment under multi-hazard coupling is developed by comprehensively considering multi-hazard coupling links of the Natech accident of the major infrastructure for oil and gas storage and transportation and analyzing accident probabilities and accident consequences of various units under the multi-hazard coupling; the software technologies of oblique photography, laser point cloud and three-dimensional modeling are integrated to achieve accurate and realistic restoration of outdoor, indoor and underground full-scenario facilities of the major infrastructure for oil and gas storage and transportation; and in daily management, the accident probabilities and accident consequences of various units under multi-hazard coupling are analyzed to provide a basis for reasonable arrangement of safety protection facilities and emergency evacuation drill; and in the emergency rescue stage after the accident occurs, the most probable propagation path and evolution time of the accident under multi-hazard coupling are analyzed to provided decision support for the development of emergency rescue actions.

The embodiments of the present invention are not limited by the above-described embodiments, and any other changes, modifications, replacements, combinations and simplifications made without departing from the spirit and principles of the present invention should be equivalent substitutions and are included within the scope of protection of the present invention.

To the claims:

1. A multi-hazard accident coupling three-dimensional simulation system for a major oil and gas infrastructure, comprising:
a storage, configured to store an accident three-dimensional simulation module (1), an accident chain evolution prediction module (2), a model module (3), and a database module (4); and
a processor, coupled to the storage, and configured to execute the accident three-dimensional simulation module (1), the accident chain evolution prediction module (2) and the model module (3),
wherein the accident three-dimensional simulation module (1) and the accident chain evolution prediction module (2) are respectively in signal connection with the model module (3) and the database module (4), and the accident three-dimensional simulation module (1) is in signal connection with the accident chain evolution prediction module (2); wherein
the accident three-dimensional simulation module (1) is configured for mirror mapping of a basic scenario of a major infrastructure for oil and gas storage and transportation and generation of a three-dimensional accident consequence;
the accident chain evolution prediction module (2) is configured for predicting a multi-hazard coupling accident scenario of a major oil and gas infrastructure domino accident caused by a Natech accident;
the model module (3) is configured for providing models for the accident three-dimensional simulation module (1) and the accident chain evolution prediction module (2); and
the database module (4) is configured for providing real-time data for the accident three-dimensional simulation module (1) and the accident chain evolution prediction module (2).

2. The multi-hazard accident coupling three-dimensional simulation system for the major oil and gas infrastructure according to claim 1, wherein the accident three-dimensional simulation module (1) comprises a basic scenario generating module (11) and an accident consequence simulation module (12); the basic scenario generating module (11) is configured for achieving mirror mapping of the major infrastructure for oil and gas storage and transportation, and the accident consequence simulation module (12) is configured for simulating a multi-hazard coupling accident consequence of the major oil and gas infrastructure domino accident caused by the Natech accident.

3. The multi-hazard accident coupling three-dimensional simulation system for the major oil and gas infrastructure according to claim 2, wherein the basic scenario generating module (11) comprises an oblique photography unit (111), a laser point cloud unit (112), and a three-dimensional modeling unit (113); the oblique photography unit (111) is configured for three-dimensional surveying and mapping of an outdoor basic scenario of the major infrastructure for oil and gas storage and transportation, the laser point cloud unit (112) is configured for fine modeling of an indoor basic scenario of the major infrastructure for oil and gas storage and transportation, and the three-dimensional modeling unit (113) is configured for supplementary modeling of an underground basic scenario and an overground basic scenario of the major infrastructure for oil and gas storage and transportation.

4. The multi-hazard accident coupling three-dimensional simulation system for the major oil and gas infrastructure according to claim 2, wherein the accident consequence simulation module (12) comprises an accident consequence calculation unit (121) and an accident consequence visualization unit (122); the accident consequence calculation unit (121) is configured for calculating an accident consequence, and the accident consequence visualization unit (122) is configured for performing dynamic simulation according to the accident consequence.

5. The multi-hazard accident coupling three-dimensional simulation system for the major oil and gas infrastructure according to claim 4, wherein the accident consequence comprises an accident influence range, the number of possible casualties and property loss.

6. The multi-hazard accident coupling three-dimensional simulation system for the major oil and gas infrastructure according to claim 4, wherein the accident consequence visualization unit (122) is configured for rendering dynamic accident consequences of diffusion, flame, explosion, shock wave and high-speed fragments at periphery of corresponding equipment in the basic scenario of the major infrastructure for oil and gas storage and transportation according to the accident consequences calculated by the accident consequence calculation unit (121).

7. The multi-hazard accident coupling three-dimensional simulation system for the major oil and gas infrastructure according to claim 1, wherein the model module (3) comprises a coupling probability model unit (31) and an accident consequence model unit (32); the coupling probability model unit (31) comprises damage-causing models of hazard-causing factors of various types of hazards for main facilities in the major infrastructure for oil and gas storage and transportation, and the accident consequence model unit (32) comprises accident consequence calculation modules of various types of hazards.

8. The multi-hazard accident coupling three-dimensional simulation system for the major oil and gas infrastructure according to claim 1, wherein the database module (4) comprises an Internet of Things perception base (42), a geographic information base (43), a scenario base (45), and a hazardous chemical information base (46), wherein
the Internet of Things perception base (42) is configured for storing sensor data of various perception equipment in a major oil and gas infrastructure scenario;
the geographic information base (43) is configured for storing geographic information of buildings and facility equipment on a map;
the scenario base (45) is configured for storing three-dimensional models of various buildings and facility equipment for calling of the accident three-dimensional simulation module (1); and
the hazardous chemical information base (46) is configured for storing physicochemical property information corresponding to various hazardous chemicals in the major infrastructure for oil and gas storage and transportation.

9. The multi-hazard accident coupling three-dimensional simulation system for the major oil and gas infrastructure according to claim 8, wherein the database module (4) further comprises a management information base (41) and an enterprise base (44), wherein
the management information base (41) is configured for storing platform login account information; and
the enterprise information base (44) is configured for storing enterprise management data.

10. The multi-hazard accident coupling three-dimensional simulation system for the major oil and gas infrastructure according to claim 8, wherein the sensor data stored in the Internet of Things perception base (42) comprises static data and dynamic data.
